(19) United States
(12) Patent Application Publication
(10) Pub. No.: US 2006/0184699 A1
(43) Pub. Date: Aug. 17, 2006

(54) Expansion apparatus for a vehicle display device

(76) Inventor: Kai-Cheng Huang, Taipei City (TW)

Correspondence Address: BIRCH STEWART KOLASCH & BIRCH, PO BOX 747, FALLS CHURCH, VA, 22040-0747, US

(21) Appl. No.: 11/058,180

(22) Filed: Feb. 16, 2005

(51) Int. Cl. G06F 3/00

(52) U.S. Cl. 710/1

(57) ABSTRACT

An expansion apparatus for a vehicle display device aims to upgrade and expand the function of a car ceiling display device without changing the original video and audio playing system. The expansion apparatus includes a body which houses a built-in multimedia processing equipment. The body has one side fastened to the car top and another side coupled with the original car ceiling display device. The multimedia processing equipment includes a signal switch to enable users to select video and audio signals from the original video and audio playing system or the newly added multimedia processing equipment thereby to achieve the object of functional expansion.

### FIELD OF THE INVENTION

The present invention relates to an expansion apparatus for a display device and particularly to an expansion apparatus for a vehicle display device that has a built-in multimedia processing equipment.

### BACKGROUND OF THE INVENTION

The popularity of vehicles increases constantly in recent years. With advances of technology, vehicle performance and comfort also improve continuously. For instance, the radio is the first entertainment system available in cars. Then tape and CD playing functions are gradually included. These days many vehicles have installed a multimedia player to make seeing VCD and DVD digital films possible. These video and audio devices initially appear only in high-end vehicles. With the RV/SUV become very popular nowadays, those multimedia players also penetrate in the general consumer market. Hence passengers can be entertained and amused in the bored and dull trip.

Most video and audio playing systems for vehicles now on the market, such as the patent application entitled “Screen swiveling mechanism” submitted by the Applicant in R.O.C. on Dec. 16, 2004, are a ceiling display device attached to the car top at the rear seat in a vehicle. The angle of the display device may be adjusted according to user's requirements. It plays synchronously with a display device installed on the front seat. Namely, the display devices on the rear seat and the front seat are controlled by a player located in the rear compartment or the front seat to broadcast concurrently. When in use, an optical disk has to be loaded into the player located in the rear compartment or the front seat, and the passengers on the rear seat have to see the same program with the passengers on the front seat. The passengers on the rear seat cannot play and see different movies or programs as desired.

To remedy this problem, R.O.C. Patent Publication No. 501855 discloses a structure that couples a DVD player and a ceiling LCD TV together. It is more convenient in use, and the passengers on the rear seat can select programs and movies according to their desire.

Although the aforesaid technique overcomes the problems of the conventional video and audio playing system in the car, it adopts an independent design. Namely, the device is installed on the rear seat separately, and cannot be connected to the system at the front seat through a signal switch. As a result, the devices on the front seat and the rear seat cannot broadcast the same movie or program. Moreover, an extra equipment has to be purchased. For the vehicle that already has a video and audio playing system, the display device already installed on the rear seat cannot be upgraded and expanded. The entire set has to be removed and replaced. It is an additional expense.

### SUMMARY OF THE INVENTION

Therefore the present invention aims to provide an expansion apparatus for a vehicle display device that expands the function of an original ceiling display device in the car so that it can be selectively connected to the original video and audio playing system, or to a newly added multimedia processing equipment.

To achieve the foregoing object, an embodiment of the expansion apparatus for a vehicle display device according to the invention includes a body, a fastening device and a multimedia processing equipment. The multimedia processing equipment is fastened to the body through the fastening device. The body has one side fastened to the car top and another side coupled with an original car ceiling display device. Through the expansion apparatus of the invention, the function of the original car ceiling display device may be upgraded. And through a signal switch, it can select to broadcast synchronously with the original video and audio playing system, or select to be connected to the newly added multimedia processing equipment to play independently. Hence the function of the original car ceiling display device may be expanded. The multimedia processing equipment is an optical disk drive, or includes a card reader or a hard disk to process multimedia in varying fashions.

The foregoing, as well as additional objects, features, and advantages of the invention will be more readily apparent from the following detailed description, which proceeds with reference to the accompanying drawings.

### BRIEF DESCRIPTION OF THE DRAWINGS

FIG. 1 is a perspective view of an embodiment of the expansion apparatus for a vehicle display device of the present invention.

FIG. 2 is an exploded view of the embodiment of the expansion apparatus for a vehicle display device from a rear side.

FIG. 3 is an exploded view of the embodiment of the expansion apparatus for a vehicle display device from a front side.

FIG. 4 is a schematic view of the embodiment of the expansion apparatus for a vehicle display device to be coupled with a car ceiling display device and installed on the car top.

### DETAILED DESCRIPTION OF THE PREFERRED EMBODIMENTS

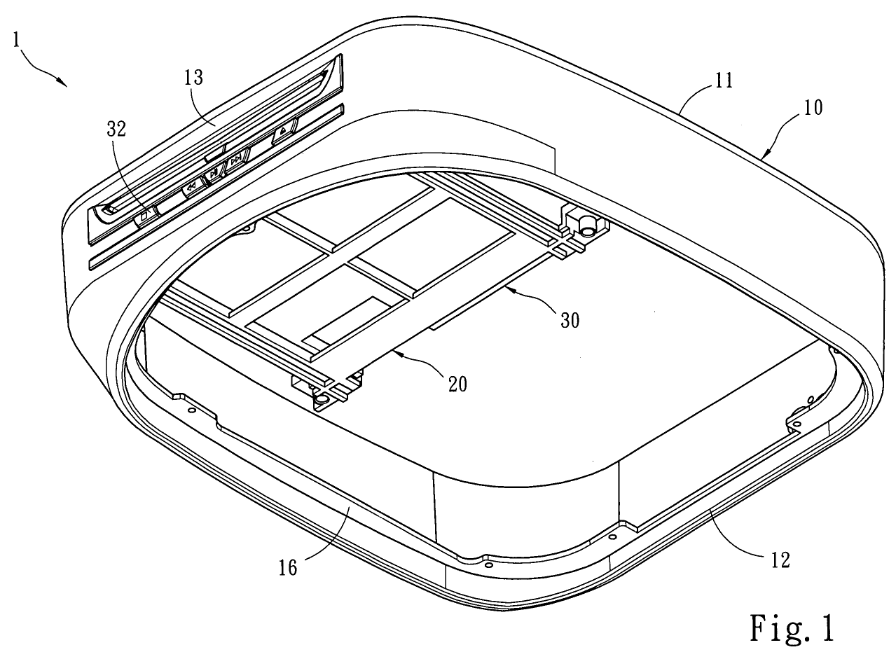

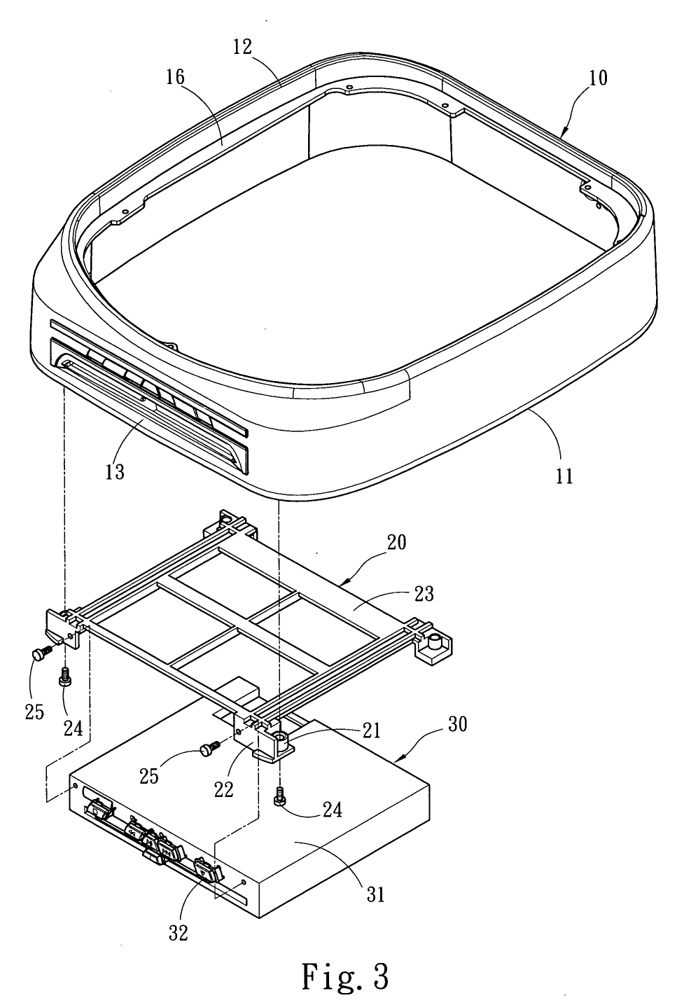

Please refer to FIG. 3 for an embodiment of the expansion apparatus 1 for a vehicle display device of the present invention. It includes a body 10 to hold a multimedia processing equipment 30 through a fastening device 20. Refer to FIG. 1 for a coupled condition.

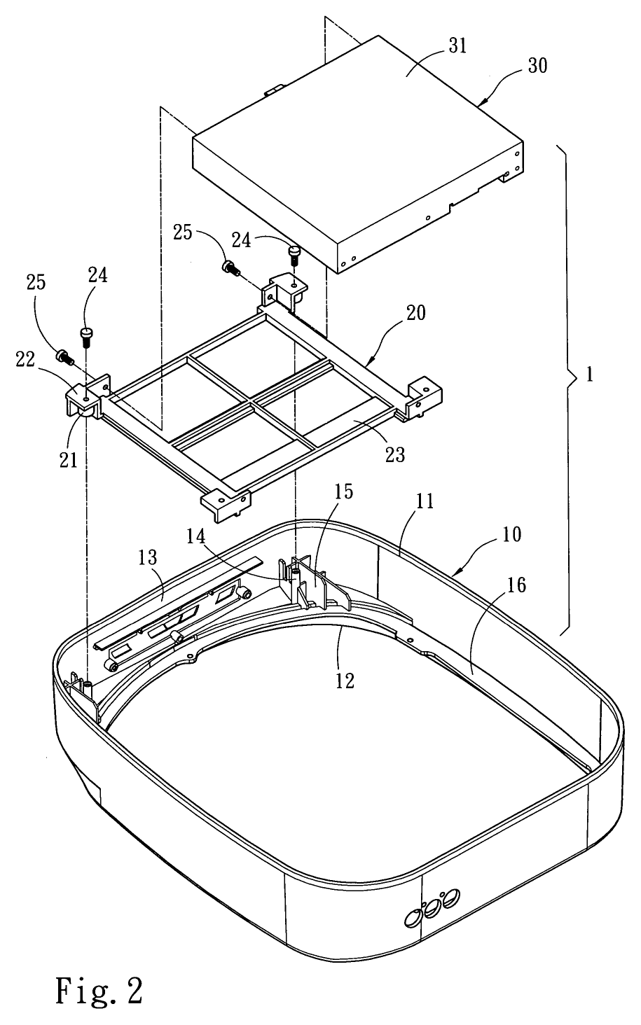

Referring to FIG. 2, the body 10 includes a first opening 11, a second opening 12, a panel 13, a plurality of first anchor elements 14, a plurality of first retaining plates 15 and a spacer 16. The body 10 is fastened to the car top (not shown in the drawings) through the first opening 11. The original car ceiling display device (not shown in the drawings) is coupled with the second opening 12 and fastened to the spacer 16.

The fastening device 20 includes a plurality of second anchor elements 21, a plurality of second retaining plates 22 and a base panel 23. The fastening device 20 is coupled with the first anchor elements 14 of the body 10 through the second anchor elements 21, and is wedged in a space formed between the second retaining plates 22 and the first retaining plates 15. In this embodiment, the first anchor element 14 and the second anchor element 21 are respectively a pin and a cavity that may be coupled and fastened by a screwing element 24 to fasten the fastening device 20 to the body 10. Of course, other coupling means may also be used to couple the fastening device 20 and the body 10.

The multimedia processing equipment 30 includes an equipment body 31 and an operation assembly 32 located on a front side. The multimedia processing equipment 30 is fastened through second screwing elements 25 in a space formed between the second retaining plates 22 of the fastening device 20 and the base panel 23. The operation assembly 32 is extended outside the panel 13 on the front side of the body 10 to enable users to operate the multimedia processing equipment 30.

The multimedia processing equipment 30 is an optical disk player to do multimedia broadcasting and output operation. It also may include a card reader (not shown in the drawings) to read a memory card that contains music or movies. The memory card is portable and can provide the multimedia processing equipment 30 versatile reading formats. In addition, the multimedia processing equipment 30 can also include a hard disk (not shown in the drawings). Then users can directly use and access data stored in the hard disk. The hard disk has a greater capacity and fast access speed, thus can enhance the added value of the multimedia processing equipment 30.

Moreover, the expansion apparatus 1 for a vehicle display device may include a signal switch (not shown in the drawings). The signal source of switching the original car ceiling display device is from the original video and audio playing system that can broadcast synchronously with the display device on the front seat, or from the multimedia processing equipment 30 connecting to car ceiling display device. Therefore the function of the original car ceiling display device may be upgraded to independently perform multimedia process.

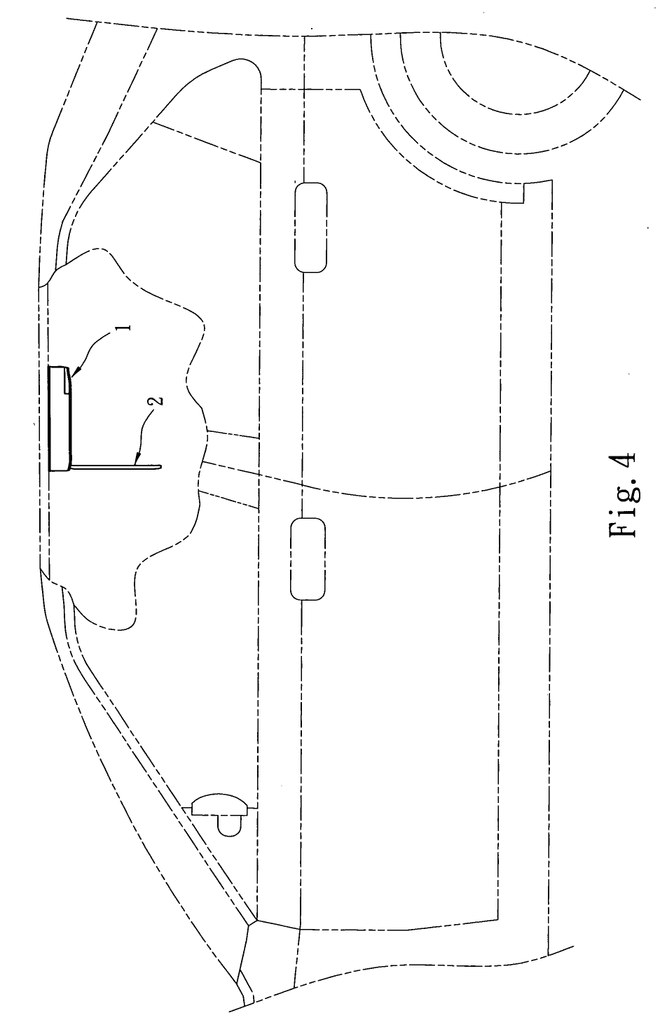

Referring to FIG. 4, when the invention is in use, the expansion apparatus 1 for a vehicle display device is fastened to the car top through the first opening 11. The second opening 12 is coupled with the original car ceiling display device 2. The viewing angle of the car ceiling display device 2 may be adjusted according to the requirements of users. The passengers on the rear seat can select to broadcast films or music according to their desire through the expansion apparatus 1 for a vehicle display device of the invention, or connect to the original video and audio playing system through the signal switch to simultaneously broadcast the same program with the display device on the front seat.

In summary, the expansion apparatus 1 for a vehicle display device according to the invention aims to expand the function of the original car ceiling display device 2 without changing the original video and audio playing system. By installing a signal switch, users can select linking to the original video and audio playing system for broadcasting, or performing multimedia processing independently through the expansion apparatus 1 for a vehicle display device.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. An expansion apparatus for a vehicle display device to be coupled with a car ceiling display device, comprising:
a body which has one side fastened to a car top and another side coupled with the car ceiling display device; and
a multimedia processing equipment which is fastened to the body through a fastening device and connected to the car ceiling display device.

2. The expansion apparatus of claim 1, wherein the expansion apparatus for a vehicle display device has a signal switch to allow the car ceiling display device to be selected from connecting to an original video and audio playing system and independently performing multimedia processing through the multimedia processing equipment.

3. The expansion apparatus of claim 1, wherein the multimedia processing equipment is an optical disk playing device.

4. The expansion apparatus of claim 1, wherein the multimedia processing equipment includes a card reader to read data of a memory card.

5. The expansion apparatus of claim 1, wherein the multimedia processing equipment includes a hard disk to access data of the hard disk.
